(19) United States
(12) Patent Application Publication
(10) Pub. No.: US 2022/0012600 A1
(43) Pub. Date: Jan. 13, 2022

(54) DERIVING PRECISION AND RECALL IMPACTS OF TRAINING NEW DIMENSIONS TO KNOWLEDGE CORPORA

(71) Applicant: INTERNATIONAL BUSINESS MACHINES CORPORATION, Armonk, NY (US)

(72) Inventors: Craig M. Trim, Ventura, CA (US); Martin G. Keen, Cary, NC (US); Sarbajit K. Rakshit, Kolkata (IN); Shikhar Kwatra, Raleigh, NC (US)

(21) Appl. No.: 16/925,496

(22) Filed: Jul. 10, 2020

(51) Int. Cl. G06N 5/02; G06N 5/04; G06K 9/62; G06Q 10/04

(52) U.S. Cl. CPC G06N 5/022; G06N 5/04; G06Q 10/04; G06K 9/6262; G06K 9/6256

(57) ABSTRACT

A method, computer system, and computer program product for deriving precision and recall impacts of training new dimensions to knowledge corpora are provided. The embodiment may include analyzing a knowledge corpus of multiple AI systems to identify distribution of knowledge contents in different dimensions. The embodiment may also include calculating a bias core of an answer provided by a user based on a pattern of the answer and user feedback. The embodiment may further include analyzing the knowledge corpus of each AI system individually with a confidence score of each answer. The embodiment may also include recommending unlearning of one or more of the knowledge contents based on the calculated confidence score. The embodiment may further include notifying the user when one or more AI knowledge corpus are determined to be trained with additional information in one or more dimensions.

### BACKGROUND

The present invention relates, generally, to the field of computing, and more particularly to training new dimensions to knowledge corpora for cognitive systems.

Cognitive systems are designed to learn from their experiences with data. A typical cognitive system uses machine learning algorithms to build models for answering questions. In a cognitive computing application, the corpus or corpora represent the body of knowledge the system can use to answer questions. The maturity of any knowledge corpus is dependent mainly upon training and a cognitive system may be over-trained in a particular dimension.

### SUMMARY

According to one embodiment, a method, computer system, and computer program product for deriving precision and recall impacts of training new dimensions to knowledge corpora are provided. The embodiment may include analyzing a knowledge corpus of multiple AI systems to identify distribution of knowledge contents in different dimensions. The embodiment may also include calculating a bias core of an answer provided by a user based on a pattern of the answer and user feedback. The embodiment may further include analyzing the knowledge corpus of each AI system individually with a confidence score of each answer. The embodiment may also include recommending unlearning of one or more of the knowledge contents based on the calculated confidence score. The embodiment may further include notifying the user when one or more AI knowledge corpus are determined to be trained with additional information in one or more dimensions.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a new dimension precision and recall impact deriving process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to training new dimensions to knowledge corpora for cognitive systems. The following described exemplary embodiments provide a system, method, and program product to derive the precision and inherent bias in a knowledge corpus and quantify the precision or recall trade-off of the knowledge corpus in response to the impact of training the knowledge corpus with new dimensions. Therefore, the present embodiment has the capacity to improve the technical field of training cognitive systems by improving teaching new dimensions to expert system knowledge corpora for the purpose of retaining existing users, attracting new users, and improving true positive results for key stakeholders.

As previously described, cognitive systems are designed to learn from their experiences with data. A typical cognitive system uses machine learning algorithms to build models for answering questions. In a cognitive computing application, the corpus or corpora represent the body of knowledge the system can use to answer questions. The maturity of any knowledge corpus is dependent mainly upon training and a cognitive system may be over-trained in a particular dimension.

A dimension may be travel-related, weather-related, or take into account points of attractions or popular cultural references. Training multiple dimensions may increase the recall that any expert system might have in answering a question. However, a problem may arise as increases in the recall may lead to more false-positive results. Moreover, in training dimensions, confidence levels in a given topic, concept, method, or decision may be influence by the readiness in which they come to the mind of users according to the availability heuristic. For instance, although shark attacks take pace very rarely but widely reported. The chance of being fatally attacked by a shark may be 1 in 300,000,000, whereas the chance of dying from a fall may be 1 in 20,000. According to the availability heuristic, the fear of shark attack is much greater and also assumed to be more common, than fear of falls. The same heuristic may apply to knowledge corpora as the probabilistic confidence level of a given knowledge corpus query may be influenced by what data the corpus has been trained with. If a knowledge corpus trained with data skewed toward popular culture references may find more matching in more queries than a knowledge corpus with a more balanced training data set. As such, it may be advantageous to, among other things, implement a system capable of identifying the presence of an availability heuristic in knowledge corpora and deriving the impact on future queries of training a knowledge corpus with additional data and providing an impact report on how the addition of a dimension to the knowledge corpus may attract new users queries or retain existing users.

For example, a data scientist may wish to evaluate the balance precision to recall trade-off of incorporating an additional popular culture dimension to an existing knowledge corpus. Utilizing the current invention, a system may derive that training of the popular culture dimension may result in increases of the false-positive ratio by 10% and the true positive ratio by 3%. However, the true positive ratio may be estimated to be 80% for the key stakeholders who may query the system. In this scenario, the above dimension may be considered a worthwhile addition to the knowledge corpus. In another case, a data scientist may wish to evaluate the impact of adding a weather dimension to an existing knowledge corpus. The system may derive that such addition may, on average, increase query time by 0.8 seconds with the additional processing required to parse the weather dimension. The increase in response time may reduce the satisfaction of existing users but may attract new users to the system. Therefore, the current invention may help make a decision based on the value of retaining existing users over attracting new users when adding the weather dimension.

According to one embodiment, the present invention may derive the precision and inherent bias in a knowledge corpus based upon the existing dimensional data taught to a knowledge corpus. The present invention may also automatically forecast precision or recall trade-off for queries to an expert system with new dimensional data taught to a knowledge corpus. The present invention may further automatically analyze forecast false and true positive results to key stakeholder queries with the introduction of new dimensional data taught to a knowledge corpus. The present invention may also apply transitive inference to recommend new dimension data to teach a knowledge corpus to retain users or expanding the reach to new users.

The present invention may be a system, a method, and/or a computer program product at any possible technical detail level of integration. The computer program product may include the computer-readable storage medium (or media) having the computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or another device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for creating a topographical map of known dimension a cognitive system may require and applying transitive inference to suggest new dimensions for further system training.

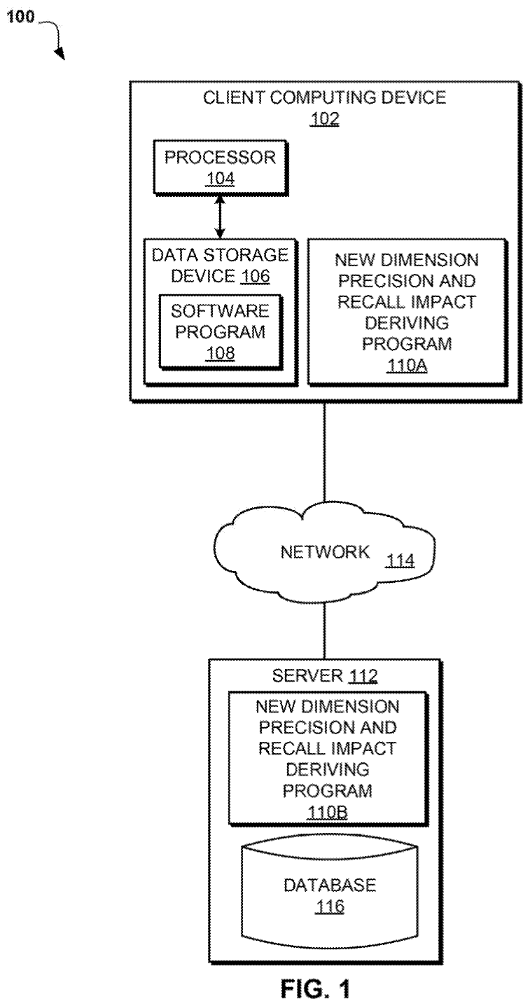

Referring to FIG. 1, an exemplary networked computer environment 100 is depicted according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

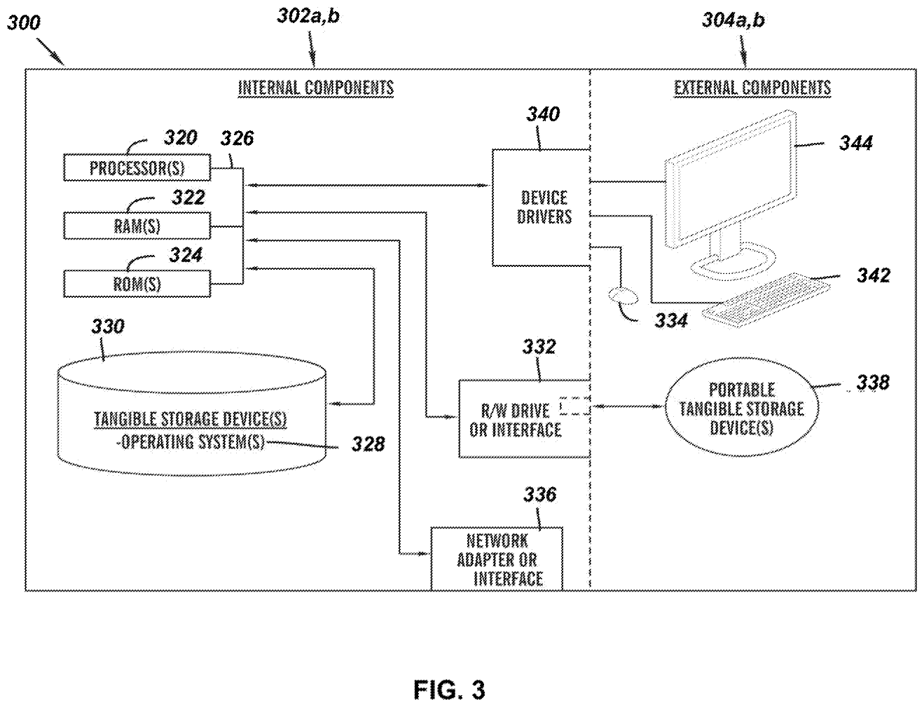

Client computing device 102 may include a processor 104 and a data storage device 106 that is enabled to host and run a software program 108 and a new dimension precision and recall impact deriving program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a new dimension precision and recall impact deriving program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

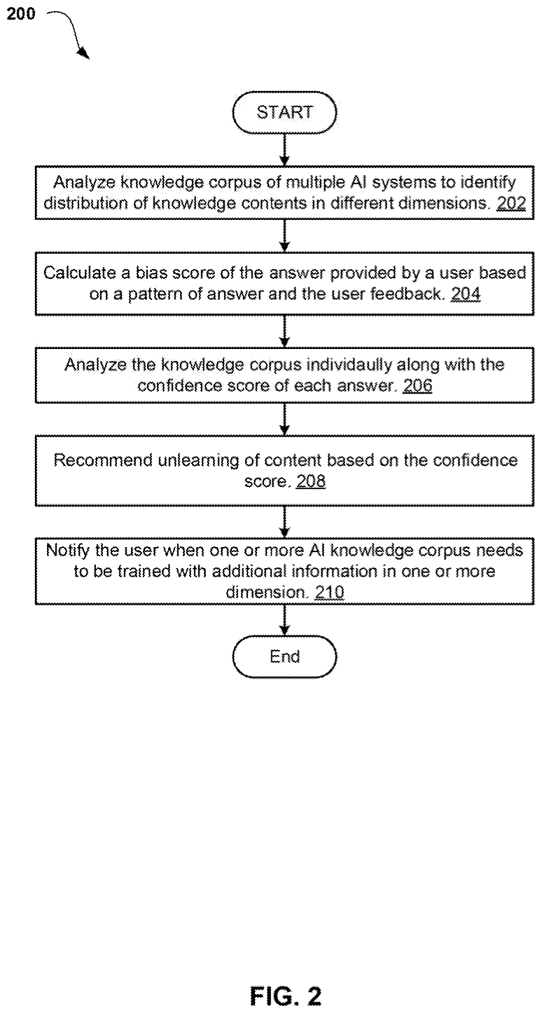

According to the present embodiment, the new dimension precision and recall impact deriving program 110A, 110B may be a program capable of deriving the precision and inherent bias in a knowledge corpus and quantifying the precision or recall trade-off of the knowledge corpus based on the predicted impact of training the knowledge corpus with new dimensions. The new dimension precision and recall impact deriving process are explained in further detail below with respect to FIG. 2.

Referring to FIG. 2, an operational flowchart illustrating a new dimension precision and recall impact deriving process 200 is depicted according to at least one embodiment. At 202, the new dimension precision and recall impact deriving program 110A, 110B analyze knowledge corpus of multiple AI systems to identify the distribution of knowledge contents in different dimensions. According to one embodiment, the new dimension precision and recall impact deriving program 110A, 110B may analyze multiple AI systems to correlate with confidence score to provide answers to various questions or provide a decision. The identified distribution of contents in different dimensions among all the AI systems and the confidence level of the answer may be utilized to identify the optimum distribution of knowledge contents in a different dimension and to recommend in later steps which area needs more knowledge to make the particular knowledge corpus mature. In another embodiment, the new dimension precision and recall impact deriving program 110A, 110B may utilize content topic identification to identify an appropriate distribution of a topic. For example, one company may have twenty different knowledge corpus for twenty different AI applications and various contents have been fed into each system during learning processes. If another AI system analyzes the same twenty knowledge corpus and identifies what types of information have been provided in different AI systems, the AI system may use the content topic identification technique to identify the distribution of the topic. If the knowledge corpus 1 comprises travel-related information for ten percent of the corpus and hotel-related data for five percent of the corpus, the new dimension precision and recalls impact deriving program 110A, 110B may correlate each data with confidence score to answer a particular query.

In yet another embodiment, the new dimension precision and recall impact deriving program 110A, 110B may track teaching of dimensions to a knowledge corpus over time and the impact of adding this dimensional data to create a topographical map of known dimensions. the new dimension precision and recall impact deriving program 110A, 110B may track dimension taught to or removed from the knowledge corpus. The new dimension precision and recall impact deriving program 110A, 110B may also track changes to performance and operation of the dimensional modification of knowledge corpus and render the tracked dimensions of a knowledge corpus in a topological map. In at least one another embodiment, the new dimension precision and recall impact deriving program 110A, 110B may further analyze usage of dimension in a knowledge corpus by tracing the usage of queries to the knowledge corpus that utilizes newly added dimensional data. For example, the new dimension precision and recall impact deriving program 110A, 110B may analyze system usage over time of queries made to an expert system utilizing a knowledge corpus and identify dimensions influencing the expert system results.

At 204, the new dimension precision and recall impact deriving program 110A, 110B calculate a biased score of the answer provided by a user based on a pattern of answer and the user feedback. According to one embodiment, the new dimension precision and recall impact deriving program 110A, 110B may consider user feedback, a pattern of answers to calculate the bias score of the answer and also correlate the answer with bias score in the curated content distribution to recommend the distribution of the content to remove the identified bias in the answer. For example, if one AI system has received user feedback and the answers having a bias, the new dimension precision and recall impact deriving program 110A, 110B may correlate the bias with the distribution of the contents. If the AI system is trained with 80% of content which may be “against” and 20% may be “for”, the new dimension precision and recall impact deriving program 110A, 110B may analyze the usage pattern of such content to recommend the user to provide more content which supports the topic which was originally 80% of “against” to reduce the bias.

At 206, the new dimension precision and recall impact deriving program 110A, 110B analyze the knowledge corpus individually along with the confidence score of each answer. According to one embodiment, the new dimension precision and recall impact deriving program 110A, 110B may analyze the knowledge corpus individually along with the confidence score of each answer, different dimensions of content distribution to recommend the user what types of content are to be provided to the system and how many of such contents need to be provided to the system. For example, the new dimension precision and recall impact deriving program 110A, 110B may analyze each individual AI system to identify an AI system that does not have weather-related data contents and determine that adding such weather information with the AI system may make the AI system mature. In yet another embodiment, the new dimension precision and recall impact deriving program 110A, 110B may derive impact analysis of the teaching of a new dimension based on derived response time changes on a per-query basis, such as in the increase in response time to processing the additional dimension in the knowledge corpus. The new dimension precision and recall impact deriving program 110A, 110B may also derive increases in types of queries that an expert system may answer with the teaching of the additional dimension in the knowledge corpus. In at least one other embodiment, the new dimension precision and recall impact deriving program 110A, 110B may forecast precision or recall trade-off of teaching new dimensions based on forecast impact on the false positive and true positive ratio of incorporating a particular dimension on a per-query basis through sampling and validation techniques. The new dimension precision and recall impact deriving program 110A, 110B may also derive the impact of the teaching of a new dimension on key stakeholders of the system based on derived most typical queries submitted by key stakeholders and forecast false and true positive return for such queries.

At 208, the new dimension precision and recall impact deriving program 110A, 110B recommend unlearning of content based on the confidence score. According to one embodiment, the new dimension precision and recall impact deriving program 110A, 110B may identify any particular topic that is unrelated to any dimensional content in the knowledge corpus or contains bias factors to recommend unlearning or removal of that content to make the AI system mature.

At 210, the new dimension precision and recall impact deriving program 110A, 110B notify the user when one or more AI knowledge corpus needs to be trained with additional information in one or more dimensions. According to one embodiment, the new dimension precision and recall impact deriving program 110A, 110B may identify one or more AI knowledge corpus that needs to be trained with additional information in one or more dimensions, then the AI system containing that knowledge corpus may inform the user about the sources of information which may be used in the training. For example, if the new dimension precision and recall impact deriving program 110A, 110B identifies that one or more AI system needs weather-related data and political data to make the systems mature, the new dimension precision and recall impact deriving program 110A, 110B may notify a user recommending which sources of information for such weather-related data and political data to consider for training purposes. In at least one other embodiment, the new dimension precision and recall impact deriving program 110A, 110B may utilize transitive inferences to suggest new dimensions to train a knowledge corpus to improve the system. the new dimension precision and recall impact deriving program 110A, 110B may derive the dimension with the highest potential to attract new users, retain existing users, or increase true positive results for key stakeholders.

It may be appreciated that FIG. 2 provides only an illustration of one implementation and does not imply any limitations with regard to how different embodiments may be implemented. Many modifications to the depicted environments may be made based on design and implementation requirements. For example, in at least one embodiment, the new dimension precision and recall impact deriving program 110A, 110B may create a summary or a report that explains each dimension with the potential score for attracting new users, retaining existing users, or increase true positive results for key stakeholders. the new dimension precision and recall impact deriving program 110A, 110B may also determine a dimension to be trained to achieve balanced results for said three goals. the new dimension precision and recall impact deriving program 110A, 110B may further quantify the precision and recall trade-off of the knowledge corpus in response to the impact of training the knowledge corpus with new dimensions.

FIG. 3 is a block diagram of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smartphone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302a,b and external components 304a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the new dimension precision and recall impact deriving program 110A in the client computing device 102 and the new dimension precision and recall impact deriving program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302a,b also includes an R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as a new dimension precision and recall impact deriving program 110A, 110B can be stored on one or more of the respective portable computer-readable tangible storage devices 338, read via the respective R/W drive or interface 332 and loaded into the respective hard drive 330.

Each set of internal components 302a,b also includes network adapters or interfaces 336 such as a TCP/IP adapter cards, wireless Wi-Fi interface cards, or 3G or 4G wireless interface cards or other wired or wireless communication links. The software program 108 and the new dimension precision and recall impact deriving program 110A in the client computing device 102 and the new dimension precision and recall impact deriving program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the new dimension precision and recall impact deriving program 110A in the client computing device 102 and the new dimension precision and recall impact deriving program 110B in the server 112 are loaded into the respective hard drive 330. The network may comprise copper wires, optical fibers, wireless transmission, routers, firewalls, switches, gateway computers and/or edge servers.

Each of the sets of external components 304a,b can include a computer display monitor 344, a keyboard 342, and a computer mouse 334. External components 304a,b can also include touch screens, virtual keyboards, touch pads, pointing devices, and other human interface devices. Each of the sets of internal components 302a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

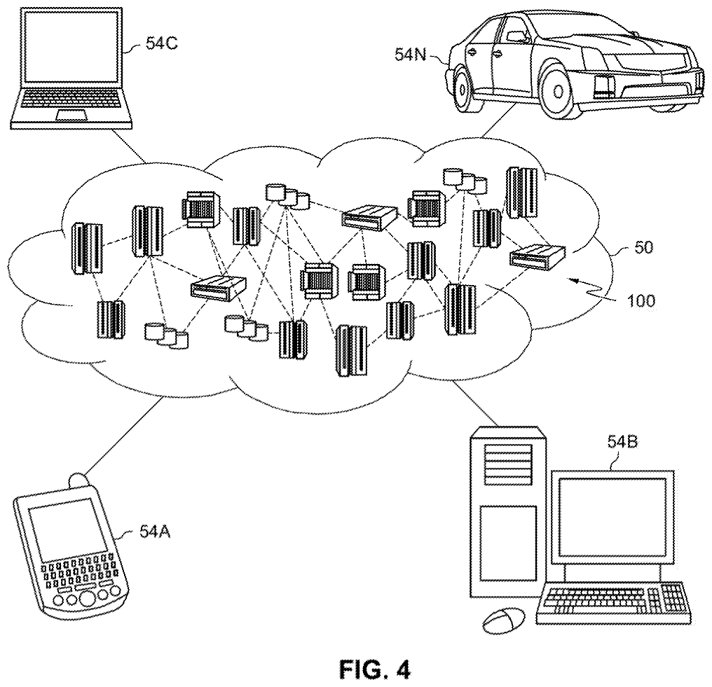

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

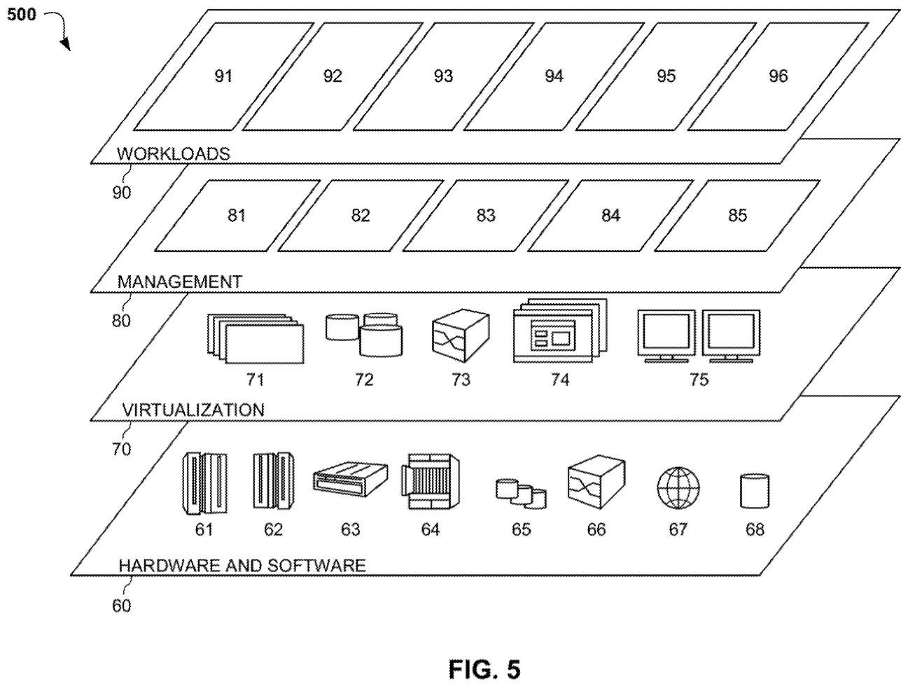

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and new dimension precision and recall impact deriving 96. New dimension precision and recall impact deriving 96 may relate to deriving the precision and inherent bias in a knowledge corpus based upon the existing dimensional data taught to a knowledge corpus.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for deriving precision and recall impacts of training new dimensions to knowledge corpora, the method comprising:
analyzing a knowledge corpus of multiple AI systems to identify distribution of knowledge contents in different dimensions;
calculating a bias core of an answer provided by a user based on a pattern of the answer and user feedback;
analyzing the knowledge corpus of each AI system individually with a confidence score of each answer;
recommending unlearning of one or more of the knowledge contents based on the calculated confidence score; and
notifying the user when one or more AI knowledge corpus are determined to be trained with additional information in one or more dimensions.

2. The method of claim 1, further comprising:
tracking dimensional data trained to the knowledge corpus over time; and
analyzing an impact of addition of the tracked dimensional data to create a topological map of known dimensions.

3. The method of claim 1, further comprising:
analyzing a usage of one of more dimensions based on tracking a usage of queries to the knowledge corpus that utilizes newly added dimensional data.

4. The method of claim 1, further comprising:
analyzing an impact of adding a new dimension to the knowledge corpus based on a response time change on a per-query basis.

5. The method of claim 1, further comprising:
forecasting an impact on false positive and true positive ratio based on incorporation of a particular dimension on a per-query basis through sampling and validation technique.

6. The method of claim 1, further comprising:
analyzing an impact of false and true positives on key stakeholders based on most typical queries submitted by key stakeholders.

7. The method of claim 1, further comprising:
deriving a dimension with the highest potential to attract new users;
deriving a dimension with the highest potential to retain existing users; and
deriving dimension with the highest potential to increase true positive results for key stakeholders.

8. A computer system for deriving precision and recall impacts of training new dimensions to knowledge corpora, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
analyzing a knowledge corpus of multiple AI systems to identify distribution of knowledge contents in different dimensions;
calculating a bias core of an answer provided by a user based on a pattern of the answer and user feedback;
analyzing the knowledge corpus of each AI system individually with a confidence score of each answer;
recommending unlearning of one or more of the knowledge contents based on the calculated confidence score; and
notifying the user when one or more AI knowledge corpus are determined to be trained with additional information in one or more dimensions.

9. The computer system of claim 8, further comprising:
tracking dimensional data trained to the knowledge corpus over time; and
analyzing an impact of addition of the tracked dimensional data to create a topological map of known dimensions.

10. The computer system of claim 8, further comprising:
analyzing a usage of one of more dimensions based on tracking a usage of queries to the knowledge corpus that utilizes newly added dimensional data.

11. The computer system of claim 8, further comprising:
analyzing an impact of adding a new dimension to the knowledge corpus based on a response time change on a per-query basis.

12. The computer system of claim 8, further comprising:
forecasting an impact on false positive and true positive ratio based on incorporation of a particular dimension on a per-query basis through sampling and validation technique.

13. The computer system of claim 8, further comprising:
analyzing an impact of false and true positives on key stakeholders based on most typical queries submitted by key stakeholders.

14. The computer system of claim 8, further comprising:
deriving a dimension with the highest potential to attract new users;
deriving a dimension with the highest potential to retain existing users; and
deriving dimension with the highest potential to increase true positive results for key stakeholders.

15. A computer program product for deriving precision and recall impacts of training new dimensions to knowledge corpora, the computer program product comprising:
one or more computer-readable tangible storage media and program instructions stored on at least one of the one or more tangible storage media, the program instructions executable by a processor of a computer to perform a method, the method comprising:
analyzing a knowledge corpus of multiple AI systems to identify distribution of knowledge contents in different dimensions;
calculating a bias core of an answer provided by a user based on a pattern of the answer and user feedback;
analyzing the knowledge corpus of each AI system individually with a confidence score of each answer;
recommending unlearning of one or more of the knowledge contents based on the calculated confidence score; and
notifying the user when one or more AI knowledge corpus are determined to be trained with additional information in one or more dimensions.

16. The computer program product of claim 15, further comprising:
tracking dimensional data trained to the knowledge corpus over time; and
analyzing an impact of addition of the tracked dimensional data to create a topological map of known dimensions.

17. The computer program product of claim 15, further comprising:
analyzing a usage of one of more dimensions based on tracking a usage of queries to the knowledge corpus that utilizes newly added dimensional data.

18. The computer program product of claim 15, further comprising:
analyzing an impact of adding a new dimension to the knowledge corpus based on a response time change on a per-query basis.

19. The computer program product of claim 15, further comprising:
analyzing an impact of false and true positives on key stakeholders based on most typical queries submitted by key stakeholders.

20. The computer program product of claim 15, further comprising:
deriving a dimension with the highest potential to attract new users;
deriving a dimension with the highest potential to retain existing users; and
deriving dimension with the highest potential to increase true positive results for key stakeholders.
